(19) United States
(12) Patent Application Publication
(10) Pub. No.: US 2004/0171776 A1
(43) Pub. Date: Sep. 2, 2004

(54) Process for manufacturing PVDF

(76) Inventor: Patrick Kappler, Ecully (FR)

Correspondence Address: Thomas F. Roland, Esq., ATOFINA Chemicals, Inc., 2000 Markt Street, Patend Department - 26th Floor, Philadelphia, PA, 19103-3222, US

(21) Appl. No.: 10/760,696

(22) Filed: Jan. 20, 2004

(30) Foreign Application Priority Data
Jan. 23, 2003 (FR) FR 03.00716

(51) Int. Cl. C08F 114/18

(52) U.S. Cl. 526/255

(57) ABSTRACT

The present invention relates to a process for manufacturing PVDF homopolymer or copolymer by radical polymerization of vinylidene fluoride (VDF) and optionally of a comonomer, in aqueous dispersion in the presence of:

HFA161 (CH₃—CH₂F) as transfer agent;

a radical initiator;

optionally, a dispersing additive.

### FIELD OF THE INVENTION

Polymers based on vinylidene fluoride CF₂═CH₂ (VDF) such as, for example, PVDF (polyvinylidene fluoride) are known to provide excellent mechanical stability properties, very great chemical inertness and good ageing resistance. These qualities are exploited in varied fields of application. For example, mention may be made of the manufacture of extruded or injection-moulded parts for the chemical engineering industry or for microelectronics, the use in the form of a sealing sheath for transporting gases or hydrocarbons, the production of protective films or coatings in the architectural field, and the production of protective elements for electrical engineering uses.

The present invention relates to a process for manufacturing a PVDF homopolymer or copolymer, more specifically a process for the radical polymerization of vinylidene fluoride (VDF) and optionally of a comonomer, in aqueous dispersion using HFA161 (CH₃—CH₂F) as the transfer agent.

### BACKGROUND OF THE INVENTION

Patent Application U.S. Pat. No. 3,857,827 discloses a process for preparing a thermally stable PVDF in aqueous emulsion. The reaction mixture comprises a fluorinated emulsifier (a perfluorinated carboxylic acid salt), peroxydicarbonate as initiator and acetone as transfer agent.

U.S. Pat. No. 4,360,652 discloses a process for the emulsion polymerization of VDF, in which the transfer agent is isopropyl alcohol.

Patent Application U.S. Pat. No. 5,095,081 discloses a process for the emulsion polymerization of VDF, in which the use of an emulsifier is not required and in which the transfer agent is an alkyl acetate.

U.S. Pat. No. 4,569,978 discloses the polymerization of VDF in the presence of a surfactant, an initiator and trichlorofluoromethane or isopropyl alcohol, the latter two compounds being transfer agents. The yellowing of PVDF, during its melt processing, is greatly reduced. The initiator is always added after some or all of the transfer agents.

In Patent Application U.S. Pat. No. 5,473,030, trifluorodichloroethane (HCFC 123 or 1,1,1-trifluoro 2,2-dichloroethane) is disclosed as transfer agent for the emulsion polymerization of the VDF, with as objective to improve the characteristics of the polymer in terms of variation in colour at high temperature. The chain transfer agent is introduced partly at the start of polymerization and then in increments progressively as the PVDF forms.

Patent Application U.S. Pat. No. 4,524,194 discloses a process for preparing PVDF in suspension, using dialkyl carbonates as transfer agents.

The transfer agents disclosed in U.S. Pat. No. 5,473,030 and in U.S. Pat. No. 4,569,978 have drawbacks associated with their discharges into the atmosphere, in particular as regards preservation of the ozone layer.

It has now been found that it is possible to use HFA161 (CH₃—CH₂F) as the transfer agent and that a PVDF of very high thermal stability is obtained, while maintaining the productivity of the process.

### SUMMARY OF THE INVENTION

The present invention relates to a process for manufacturing PVDF homopolymer or copolymer by radical polymerization of vinylidene fluoride (VDF) and optionally of a comonomer, in aqueous dispersion in the presence of:

HFA161 (CH₃—CH₂F) as transfer agent;

a radical initiator;

optionally, a dispersing additive.

According to an advantageous embodiment, the invention is a batch or semi-continuous process for the manufacture of PVDF homopolymer or copolymer, in which:

the polymerization reactor is charged with water, the optional dispersing additive and optionally a paraffin wax;

the reactor is deaerated in order to remove the oxygen;

the reactor is heated to the chosen temperature and charged with the VDF and the optional monomer until the desired pressure is reached;

the transfer agent (HFA161) is introduced into the reactor either in total or partly at the start and partly during the polymerization;

the initiator is added in total or partly, in order to start the polymerization and the drop in pressure that results therefrom is compensated for by the addition of VDF and the optional comonomer;

the optional remainder of the initiator is added during polymerization; and

after introducing the intended amount of VDF and optional comonomer, the reactor is degassed and the PVDF is separated by any means from the water and the optional residues of the reactants involved.

The chosen temperature is the temperature sufficient to polymerize the VDF and is about 45 to 130° C. The desired pressure is about 40 to 120 bar.

The volume of water in which the monomers are dispersed and the amounts of dispersing additive, of initiator and of transfer agent can be easily determined by a person skilled in the art. The polymerization is carried out in a stirred reactor and then the PVDF (it is in the form of solid particles) is separated from the water by any means. These techniques are known per se and described in U.S. Pat. No. 4,025,709, U.S. Pat. No. 4,569,978, U.S. Pat. No. 4,360,652, EP 626 396 and EP 0 655 468.

Depending on the nature of the dispersing additive and its proportions, the process is called an “emulsion” process, a “suspension” process or any other process derived from emulsion or suspension (microsuspension, miniemulsion, etc.) processes, these being completely known to those skilled in the art. After the end of polymerization, the PVDF is separated from the water and from any residues of the reactants involved.

In the case of suspension-type processes, the PVDF is in the form of a particulate dispersion, the mean particle size of which allows filtration and washing to be carried out directly, for example by passing pure water into the filtration system.

In the case of emulsion-type processes, the polymer is in the form of a latex composed of very fine particles, the mean diameter of which is generally less than 1 micron. This latex may be coagulated and optionally concentrated, by removing some of the water, for example by centrifuging. In the coagulated state, it is also possible to obtain an aerated cream less dense than water, which may be washed with deionized water using techniques already described in the prior art (U.S. Pat. No. 4,218,517 and EP 0 460 284). Next, the washed cream may be dried by bringing it into contact with a hot gas in a spray dryer and the powdered PVDF is collected. This technique is known and used in PVDF manufacturing processes.

### DETAILED DESCRIPTION OF THE INVENTION

As regards the optional fluorinated comonomer, this is advantageously chosen from compounds which contain a vinyl group capable of opening by the action of free radicals in order to be polymerized and which contain, directly attached to this vinyl group, at least one fluorine atom, a fluoroalkyl group or a fluoroalkoxy group. As examples of comonomers, mention may be made of vinyl fluoride; trifluoroethylene (TRFE); chlorotrifluoroethylene (CTFE); 1,2-difluoroethylene; tetrafluoroethylene (TFE); hexafluoropropylene (HFP); perfluoro(alkyl vinyl) ethers, such as perfluoro(methyl vinyl) ether (PMVE), perfluoro(ethyl vinyl) ether (PEVE) and perfluoro(propyl vinyl) ether (PPVE); perfluoro(1,3-dioxole); perfluoro(2,2-dimethyl-1,3-dioxole) (PDD); the product of formula CF₂═CFOCF₂CF(CF₃)OCF₂CF₂X in which X is SO₂F, CO₂H, CH₂OH, CH₂OCN or CH₂OPO₃H; the product of formula CF₂═CFOCF₂CF₂SO₂F; the product of formula F(CF₂)ₙCH₂OCF═CF₂ in which n is 1, 2, 3, 4 or 5; the product of formula R₁CH₂OCF═CF₂ in which R₁ is hydrogen or F(CF₂)_{z} and z is 1, 2, 3 or 4; the product of formula R₃OCF═CH₂ in which R₃ is F(CF₂)ₙ— and z is 1, 2, 3 or 4; perfluorobutylethylene (PFBE); 3,3,3-trifluoropropene and 2-trifluoromethyl-3,3,3-trifluoro-1-propene. Several comonomers may be used. With regard to the PVDF copolymer, the proportion of VDF is at least 60% by weight per 40% of comonomer and preferably at least 85% by weight per 15% of comonomer. Advantageously, the comonomer is chosen from HFP, CTFE, TFE and TRFE.

With regard to the dispersing additive, this denotes any product capable of dispersing the monomers in water so as to make them easier to polymerize. It may be a surfactant, an emulsifying composition or a colloid. In the emulsion processes, it is advantageous to use an ionic surfactant derived from an organic acid or an organic base.

With regard to the surfactant, U.S. Pat. No. 4,025,709, U.S. Pat. No. 4,569,978, U.S. Pat. No. 4,360,652, EP 626 396 and EP 0 655468 disclose processes for synthesizing PVDF by putting VF₂ in aqueous emulsion and polymerizing it; many formulations of surfactants are found in these documents.

As an example, mention may be made of those of general formula: ZCₙF₂ₙ COOM in which Z is a fluorine or chlorine atom, n is an integer from 6 to 13 and M is a hydrogen atom or an alkali metal atom or an ammonium group or an ammonium group having at least one lower alkyl substituent.

Mention may also be made of lithium perfluoroalkanoates of formula F₃C(CF₂)ₙ₋₂CO₂Li where n=7, 8, 9 and 10.

The amount of surfactant introduced at the start or during polymerization may be between 0.05 and 0.5% by weight of the total charge of the fluoromonomers employed.

Advantageously, in addition to the surfactant, a paraffin wax may also be added. The paraffin wax used has a melting point ranging from 40 to 70° C. and represents from 0.005 to 0.1% by weight with respect to the total weight of the fluoromonomers.

With regard to the colloid, this may be chosen from the standard suspension agents, such as polyvinyl alcohols and water-soluble cellulose derivatives, such as alkyl celluloses or alkyl hydroxyalkyl celluloses.

As regards the initiator, this denotes any radical generator capable of polymerizing the fluoromonomers in the process described above. Preferably, the initiator (or radical initiator) used represents from 0.10 to 2% by weight with respect to the total weight of the fluoromonomer(s) employed.

Advantageously this is an organosoluble initiator. Mention may essentially be made of hydrocarbon peroxides, such as di-tert-butylperoxide, di-cumyl peroxide or benzoyl peroxide, dialkyl peroxydicarbonates, such as diethyl peroxydicarbonate or diisopropyl peroxydicarbonate or di-n-propyl peroxydicarbonate, peracids or peresters, such as t-butyl perpivalate, t-amyl perpivalate or t-butyl peroxybenzoate.

As regards the transfer agent, and therefore HFA161 (CH₃—CH₂F), this is used in an amount by weight of 0.05 to 5% with respect to the total charge of fluoromonomers employed for the polymerization. The choice of transfer agent in a radical polymerization process must mainly meet two criteria:

1) they allow a polymer of good thermal stability to be obtained. The thermal stability of the polymer may be affected either by undesirable decomposition products or by unstable chain ends owing to the effect of a heat treatment;

2) be effective at low contents.

In general, these two criteria are assessed in the following manner:

Thermal stability: A plaque is compression-moulded from powder. This 4 mm thick plaque is then heated to 265° C. for 1 h in an oven of the Metrastat® PSD 260 brand. The colour of the plaque is characterized by a yellowing index corresponding to the ASTM 1925 standard. It is determined using a calorimeter of the Minolta® CR200 brand. The product is yellower the higher the yellowing index Y1.

The efficiency of the transfer agent: the efficiency is related to the amount of transfer agent needed to produce 1 kg of polymer of defined molecular masses. The molecular masses are determined both by the GPC (Gell Permeation Chromatography) technique, also called SEC (Steric Exclusion Chromatography), and by measuring the melt flow index or MFI. The GPC is carried out in dimethylformamide at 70° C. The weight-average molecular mass \overline{M}_{w} is expressed as polystyrene equivalent. The MFI is measured at 230° C. under a load of 5 kg according to the ISO 1133 standard and is expressed in g/10 min. To express the efficiency as transfer agent by a comparable value, we have determined an apparent transfer constant alpha on the basis of the average mass \overline{M}_{w} and the (weight charge of transfer agent)/(total weight charge of VDF and optional comonomer) ratio denoted by (CTA)/(VDF):

$$\frac{1}{{M}_{w}} = {1.9310}^{- 6} + \text{alpha} ( CTA ) \text{/} ( VDF ) .$$

The constant alpha is higher the more effective the transfer agent.

The process of the invention using an emulsion will now be described in greater detail. In general, the process according to the invention may be carried out in the following manner.

Advantageously, an aqueous dispersion of the initiator stabilized by a surfactant used for carrying out the polymerization is prepared. To produce this dispersion, water, the initiator and the surfactant are mixed in a disperser. It is this dispersion which is added at the start of and then optionally during polymerization.

a) Polymerization: after charging the polymerization reactor with water, the surfactant and optionally the paraffin wax, the transfer agent is added, the reactor is pressurized, after having removed the oxygen, adding thereto vinylidene fluoride by itself or as a mixture with the comonomer, and heated to the chosen temperature. Advantageously, the aqueous emulsion is polymerized at a temperature of 45 to 130° C. Preferably, the polymerization is carried out at an absolute pressure of 40 to 120 bar. The reaction is started by adding the initiator dispersion.

During polymerization, the VDF, by itself or as a mixture with a comonomer, is optionally added in order to maintain the pressure or to obtain a controlled pressure variation. Optionally, the initiator is added in increments or continuously. After introducing the planned amount of fluoromonomer(s), the reactor is degassed and the latex drained off.

b) Finishing:

Washing: The latex is diluted and then introduced into a coagulator where it is subjected to a shearing action in the presence of air. Under the combined effect of these two actions, the latex is converted into an aerated cream of density less than that of water.

Optionally, this cream is countercurrently washed with deionized water, for example using the process described in U.S. Pat. No. 4,128,517 and EP 0 460 284. Washing with water makes it possible to strip from the latex the surfactant that was required for polymerization.

Drying: On leaving the washing column or immediately after coagulation, the aerated cream is sent to a storage container before being sent, by pumping, into a spray dryer which converts it into a dry powder.

This drying step in a spray dryer may also be applied to the initial latex, optionally diluted, to the coagulated latex, for example coagulated by mechanical shear with or without prior dilution, or else to the aerated cream.

The spray dryer air inlet and outlet temperatures are determined so as to obtain maximum efficiency in terms of productivity and improvement in PVDF coloration. In general, the inlet air temperature will be between 130 and 200° C. and the outlet air temperature between 70 and 120° C. Advantageously, these two temperatures will be between 140 and 180° C. and 80 and 100° C., respectively.

A powder having a bulk density of 0.3 to 0.4 with a particle size of between 1 and 20 pm is obtained.

### EXAMPLES

### Example 1

a) Preparation of an initiator emulsion. A mixture of 1620 g of dionized water, 33 g of n-propyle peroxydicarbonate (nPP) and 3.4 g of ammonium perfluorononanoate was stirred using a turbine stirrer. The emulsion was checked at 0° C. before being introduced into the reactor.

b) Polymerization. The following were introduced into a reactor fitted with a stirrer, a jacket and an internal temperature regulation system:

18.4 kg of dionized water;

64.4 g of a 15 wt % ammonium perfluorooctanoate solution; and

1.4 g of paraffin wax having a melting point of 60° C.

The reactor was deaerated using a vacuum pump and heated to 83° C. with stirring. After 21 g of HFA161 were added to the reactor, the VDF was introduced until a pressure of 45 bar was reached. During polymerization, 1460 g of the nPP emulsion described in § a, i.e. 29 g of nPP were introduced. Pressure was maintained at 45 bar by adding VDF. After having introduced a total charge of 8.6 kg of VDF, the feed of VDF and nPP emulsion was stopped. The pressure decreased to 10 bar, at which pressure the reactor was degassed. 27.8 kg of latex were recovered. After drying, 8.05 kg of PVDF were obtained. The polymerization time was 3 h 15 min.

c) Coagulation, washing and drying. The coagulation and washing were carried out according to the teaching of U.S. Pat. No. 4,128,517. The latex was diluted so as to have a solids content of 12%, and then introduced into a 12 litre coagulator at a rate of 18 l/h. At the same time, air was introduced at a rate of 15 l/h. The latex was coagulated by the shear produced by the turbine stirrer (blade tip velocity: 12 m/s) and converted into a cream having a density of less than that of water. This cream was introduced into a 14 litre washing column fed at the top at a rate of 140 l/h. The coagulated and washed latex stock leaving the washing column was introduced into an intermediate container from which it was sent to a 1 m³ spray dryer. The temperature of the air was 85° C. at the inlet and 140° C. at the outlet of the spray dryer.

The following tests were carried out on the powder obtained after spray drying:

Melt flow index (MFI) according to the ISO 1153 standard at 230° C./5 kg;

Average molecular mass \overline{M}_{w} by GPC; solvent: dimethylformamide;

T=70° C.; result in polystyrene equivalent;

Yellowing index Y1 on a 4 mm thick moulded plaque heated for 1 h at 265° C. in an oven of the Metrastat® PSD 260 brand.

### Comparative Examples a-d

In the comparative examples a-d, the transfer agent used was, respectively:

| | |
|---|---|
| trichlorofluoromethane CCl₃F (CFC11) | Ex. a |
| HFA-152a (CH₃—CF₂H) | Ex. b |
| ethyl acetate | Ex. c |
| diethyl carbonate | Ex. d. |

The polymerization was carried out in a similar manner to Example 1. The total charge of VDF, the amount of PVDF formed and the polymerization time are given in Table 1. Table 2 compares the thermal stability and efficiency characteristics associated with the use of the various transfer agents.

TABLE 1

| | Transfer Agent | | | | NPP | Poly. | Weight |
|---|---|---|---|---|---|---|---|
| | | | amount | VDF | Charge | Time | of PVDF |
| Ex. | name | formula | (g) | charge | (g) | (h) | Formed (g) |
| 1 | HFA161 | CH₃—CH₂F | 21 | 8500 | 29 | 3 h 15 | 8050 |
| a | CFC 11 | CFCl₃ | 80 | 8500 | 28 | 2 h 55 | 8000 |
| b | HFA 152a | CH₃—CHF₂ | 140 | 8500 | 28 | 3 h 05 | 8000 |
| c | Ethyl | C₂H₅OCO—CH₃ | 22 | 8500 | 28 | 2 h 50 | 8010 |
| | acetate | | | | | | |
| d | Diethyl | (C₂H₅—O₂—CO | 20 | 8500 | 30 | 3 h 03 | 8020 |
| | carbonate | | | | | | |

TABLE 2

| | | Thermal | | | | |
|---|---|---|---|---|---|---|
| | Transfer | Stability | | | Efficiency | Environmental |
| Ex. | agent | Y1 | M_{w} | MFI | alpha | regulation |
| 1 | HFA161 | 29 | 354000 | 1.5 | 3.4 × 10⁻⁴ | permitted |
| a | CFC 11 | 29 | 301000 | 4.6 | 1.4 × 10⁻⁴ | regulated |
| b | HFA 152a | 30 | 350000 | 1.5 | 0.52 × 10⁻⁴ | permitted |
| c | Ethyl | 40 | 310000 | 3.9 | 4.7 × 10⁻⁴ | permitted |
| | acetate | | | | | |
| d | Diethyl | 38 | 271000 | 8.2 | 7.0 × 10⁻⁴ | permitted |
| | carbonate | | | | | |

What is claimed is:

1. Process for manufacturing polyvinylidene fluoride(PVDF) homopolymer or copolymer comprising the step of radical polymerization of vinylidene fluoride (VDF) and optionally of a comonomer, in aqueous dispersion in the presence of:
HFA161 (CH₃—CH₂F) as transfer agent;
a radical initiator;
optionally, a dispersing additive.

2. Process according to claim 1, in which the proportion of VDF is at least 60% by weight per 40% of comonomer.

3. Process according to claim 2, in which the proportion of VDF is at least 85% by weight per 15% of comonomer.

4. Process according to claim 1, in which the transfer agent is used in an amount by weight of 0.05 to 5% with respect to the total charge of fluoromonomers employed for the polymerization.

5. Process according claim 4, in which the radical initiator employed comprises from 0.1 to 2% by weight with respect to the total weight of the fluoromonomer(s) employed.

6. Process according to claim 1, in which the dispersing additive comprises a surfactant and its total amount introduced, at the start of or during polymerization, is between 0.05 and 0.5% by weight of the total charge of fluoromonomers employed.

7. Process according to claim 1 wherein said process is a batch or semi-continuous process.

8. Batch process or semi-continuous process for the manufacture of PVDF homopolymer or copolymer comprising the steps of:
charging a polymerization reactor with water, the optional dispersing additive and optionally a paraffin wax;
deaerating said reactor in order to remove the oxygen;
heating said reactor to the chosen temperature and charging said reactor with the VDF and the optional monomer until the desired pressure is reached;
introducing HFA161 as the transfer agent into the reactor either in total or partly at the start and partly during the polymerization;
adding initiator in total or partly, in order to start the polymerization and the drop in pressure that results therefrom is compensated for by the addition of VDF and the optional comonomer;
adding the optional remainder of the initiator during polymerization; and
degassing the reactor after introducing the intended amount of VDF and optional comonomer, and separating the PVDF by any means from the water and the optional residues of the reactants involved.
